(19) United States
(12) Patent Application Publication
(10) Pub. No.: US 2024/0359742 A1
(43) Pub. Date: Oct. 31, 2024

(54) PARKING ASSISTANCE DEVICE

(71) Applicant: AISIN CORPORATION, Kariya (JP)

(72) Inventor: Daisuke SATO, Kariya-shi (JP)

(73) Assignee: AISIN CORPORATION, Kariya (JP)

(21) Appl. No.: 18/610,581

(22) Filed: Mar. 20, 2024

(30) Foreign Application Priority Data
Apr. 27, 2023 (JP) 2023-073197

(51) Int. Cl. B62D 15/02; B62D 13/00

(52) U.S. Cl. CPC B62D 15/027; B62D 13/00

(57) ABSTRACT

Provided is a parking assistance device including a maximum value settert setting a maximum value of a curvature or a steering angle for the traveling trajectory of the towing vehicle and a trailer wheel base acquisition unit acquiring a distance from a turning center of the towed vehicle to a coupling point between the towing vehicle and the towed vehicle as a trailer wheel base. The device also includes a coupling distance acquisition unit acquiring a coupling distance from a rear axle of the towing vehicle to the coupling point between the towing and towed vehicle and a parameter specification unit specifying recommended values of the predetermined turning curvature of the towed vehicle during parking and a curvature gradient of the second section based on the trailer wheel base and the coupling distance so a curvature or a steering angle of the towing vehicle does not exceed the maximum value.

### CROSS REFERENCE TO RELATED APPLICATIONS

This application is based on and claims priority under 35 U.S.C. § 119 to Japanese Patent Application No. 2023-073197, filed on Apr. 27, 2023, the entire content of which is incorporated herein by reference.

### TECHNICAL FIELD

The present disclosure relates to a parking assistance device that assists parking of a vehicle.

### BACKGROUND DISCUSSION

Conventionally, it has been known that a traveling trajectory for parking is calculated as parking assistance of a vehicle, and guidance and vehicle control are performed such that parking is performed according to the calculated traveling trajectory. Here, particularly when the parking assistance described above is performed on the towing vehicle (tractor) towing the towed vehicle (trailer), it is necessary to calculate the traveling trajectory in consideration of not only the behavior of the towing vehicle but also the behavior of the towed vehicle.

For example, JP 2022-107175 A proposes a technique of generating a target path of a towing vehicle and a towed vehicle using a parking start position, a parking target position, and a position of an obstacle when parking is performed in a state in which the towing vehicle tows the towed vehicle, then determining whether a maximum curvature of the generated target path of the towed vehicle is equal to or less than a maximum curvature that the towed vehicle is able to turn, and correcting the target path by resetting a turning-back position when the maximum curvature is not equal to or less than the maximum curvature that the towed vehicle is able to turn.

### SUMMARY

Here, regarding the curvature of the traveling trajectory drawn by the towed vehicle when the towing vehicle towing the towed vehicle moves backward, the towed vehicle does not have a steering device, so that the curvature of the traveling trajectory of the towed vehicle is mainly determined based on the connection angle (hitch angle) between the towing vehicle and the towed vehicle as illustrated in FIG. 7. That is, as illustrated in the upper diagram of FIG. 7, when the connection angle between the towing vehicle 2 and the towed vehicle 3 is 0 degrees (located on a straight line), the curvature of the traveling trajectory that is drawn when the towed vehicle 3 is pushed by the towing vehicle 2 moving backward is zero. Incidentally, as illustrated in the lower diagram of FIG. 7, when the connection angle between the towing vehicle 2 and the towed vehicle 3 is larger than 0 degrees, the curvature of the traveling trajectory that is drawn when the towed vehicle 3 is pushed by the towing vehicle 2 moving backward is larger than zero. As the connection angle between the towing vehicle 2 and the towed vehicle 3 increases, the curvature of the traveling trajectory of the towed vehicle 3 increases (the turning radius decreases).

Here, when the towing vehicle 2 towing the towed vehicle 3 moves backward and performs parking, it is important to increase the curvature of the traveling trajectory drawn by the towed vehicle 3, in as short a time as possible to shorten the total length of the path for parking. Therefore, as illustrated in FIG. 8, first, immediately after the start of backward movement, the towing vehicle 2 generally performs a counter steering motion of intentionally steering in a direction opposite (the right direction in FIG. 8) to the original turning direction (it is the left direction in FIG. 8 because a driver desires to turn to the left rear as viewed from the driver), and then steers in the original turning direction. In contrast, it is necessary to bring the connection angle between the towing vehicle 2 and the towed vehicle 3 close to 0 degrees in a state of approaching the parking target position. However, in order to shorten the total length of the path for parking, it is effective to maintain a state where the curvature is as large as possible until the end and quickly reduce the curvature at the end, instead of gradually reducing the curvature. Therefore, it is general to perform the steering-angle increment motion to increase steering in the turning direction at the end of turning.

In JP 2022-107175 A described above, the maximum value of the curvature of the target path of the towed vehicle is adjusted to fall within an allowable range, but the gradient (change rate) of the curvature is not considered at all. As a result, there is a possibility that a target path that is untraceable is set in a section, where the gradient of curvature increases, for the counter steering motion, steering-angle increment motion, and the like described above.

A need thus exists for a parking assistance device that specifies recommended values of a maximum value and a gradient of a curvature of a traveling trajectory of a towed vehicle and makes it possible to calculate a more appropriate traveling trajectory without generating a traveling trajectory that is untraceable during parking.

In order to achieve the object, a parking assistance device according to the present disclosure is a parking assistance device that assists parking of a towing vehicle and a towed vehicle to be towed by the towing vehicle in a state where the towing vehicle and the towed vehicle are coupled, a traveling trajectory of the towed vehicle during parking including a first section directing backward and increasing a curvature from an initial curvature at a start of backward movement to a predetermined turning curvature and a second section directing backward and decreasing the curvature from the predetermined turning curvature, the parking assistance device including: a maximum value setting unit that sets a maximum value of a curvature or a steering angle allowed for the traveling trajectory of the towing vehicle; a trailer wheel base acquisition unit that acquires a distance from a turning center of the towed vehicle to a coupling point between the towing vehicle and the towed vehicle as a trailer wheel base; a coupling distance acquisition unit that acquires a coupling distance that is a distance from a rear axle of the towing vehicle to the coupling point between the towing vehicle and the towed vehicle; and a parameter specification unit that specifies respective recommended values of the predetermined turning curvature in the traveling trajectory of the towed vehicle during parking and a curvature gradient of the second section based on the trailer wheel base and the coupling distance on a condition that a curvature or a steering angle for the traveling trajectory of the towing vehicle does not exceed the maximum value.

Note that the gradient may be a change rate of gradient per unit distance or may be a change rate of gradient per unit time.

With the parking assistance device according to the present disclosure having the configuration described above is able to specify the recommended values of the maximum value and the gradient of the curvature of the traveling trajectory of the towed vehicle, based on the trailer wheel base and the distance from the rear axle of the towing vehicle to the coupling point in consideration of the maximum value of the curvature or the steering angle allowed in the traveling trajectory of the towing vehicle. As a result, it is possible to calculate a more appropriate traveling trajectory using the recommended values without generating a traveling trajectory that is untraceable during parking.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a diagram illustrating a towing vehicle and a towed vehicle according to a present embodiment;

FIG. 2 is an enlarged diagram illustrating a vicinity of a traction device of the towing vehicle;

FIG. 3 is a diagram illustrating movement of the towing vehicle and the towed vehicle in a state where a hitch ball and a coupler are connected to each other;

FIG. 4 is a block diagram illustrating a configuration of a parking assistance device according to the present embodiment;

FIG. 5 is a flowchart of a parameter specification processing program according to the present embodiment;

FIG. 6 is a diagram illustrating a virtual parking situation set to calculate a recommended parameter;

FIG. 7 is a diagram illustrating a relationship between a connection angle and a curvature of a traveling trajectory drawn by the towed vehicle;

FIG. 8 is a diagram explaining a counter steering motion and a steering-angle increment motion;

FIG. 9 is a diagram illustrating a transition of curvature of each of the traveling trajectories of the towing vehicle and the towed vehicle in a process of performing the counter steering motion and the steering-angle increment motion in the towing vehicle;

FIG. 10 is a diagram illustrating a relationship between the curvature of the traveling trajectory of the towing vehicle in the counter steering motion of the towing vehicle and a steering-angle increment curvature gradient α of the traveling trajectory of the towed vehicle;

FIG. 11 is a diagram illustrating a relationship between the curvature of the traveling trajectory of the towing vehicle in the steering-angle increment motion of the towing vehicle and a steering-angle decrement curvature gradient β of the traveling trajectory of the towed vehicle;

FIG. 12 is a diagram explaining a method of calculating a total length of a path for parking;

FIG. 13 is a diagram illustrating a relationship between a trailer wheel base and parameters specified;

FIG. 14 is a flowchart of a parking assistance processing program according to the present embodiment;

FIG. 15 is a diagram illustrating an example of a forward trajectory from a parking start position;

FIG. 16 is a diagram illustrating a candidate for turning-back position set on the forward trajectory;

FIG. 17 is a diagram illustrating a relationship between an initial curvature of a backward trajectory and a connection angle at a turning-back position;

FIG. 18 is a diagram illustrating a relationship between an initial curvature of a backward trajectory and a connection angle at a turning-back position;

FIG. 19 is a diagram illustrating an example of a backward trajectory calculated for a candidate for turning-back position;

FIG. 20 is a diagram comparing respective backward trajectories calculated for a plurality of candidates for turning-back position; and

FIG. 21 is a diagram explaining a method of correcting a candidate for turning-back position.

### DETAILED DESCRIPTION

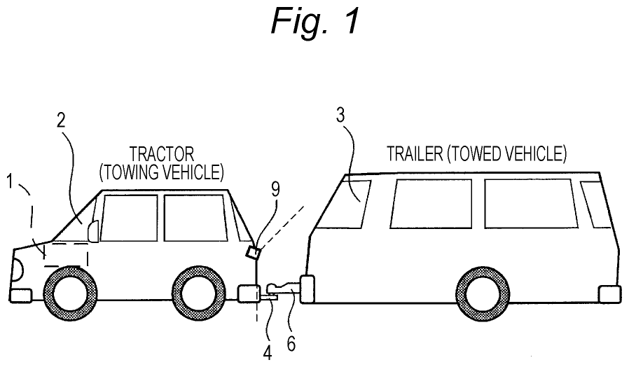

Hereinafter, a parking assistance device according to an embodiment of the present disclosure will be explained in detail with reference to the drawings. First, a towing vehicle (tractor) 2 equipped with a parking assistance device 1 according to the present embodiment and a towed vehicle (trailer) 3 towed by the towing vehicle 2 will be explained below. FIG. 1 is a diagram illustrating the towing vehicle 2 and the towed vehicle 3.

Here, the towing vehicle 2 is also referred to as tractor, and is configured to be able to travel while towing the towed vehicle 3. The towing vehicle 2 may be, for example, an automobile (internal combustion engine automobile) using an internal combustion engine (engine or the like) as a drive source, an automobile (electric vehicle, fuel cell vehicle, etc.) using an electric motor (motor or the like) as a drive source, or an automobile (hybrid automobile) using both drive sources. In addition, regardless of the vehicle type, the tractor may be a standard-sized automobile as long as a traction device 4 described later is provided, or may be a commercial large tractor (trailer head).

In addition, as illustrated in FIG. 1, the traction device 4 (hitch) for towing the towed vehicle 3 is arranged to protrude from, for example, a lower part of a central portion in the vehicle width direction of a rear bumper of the towing vehicle 2.

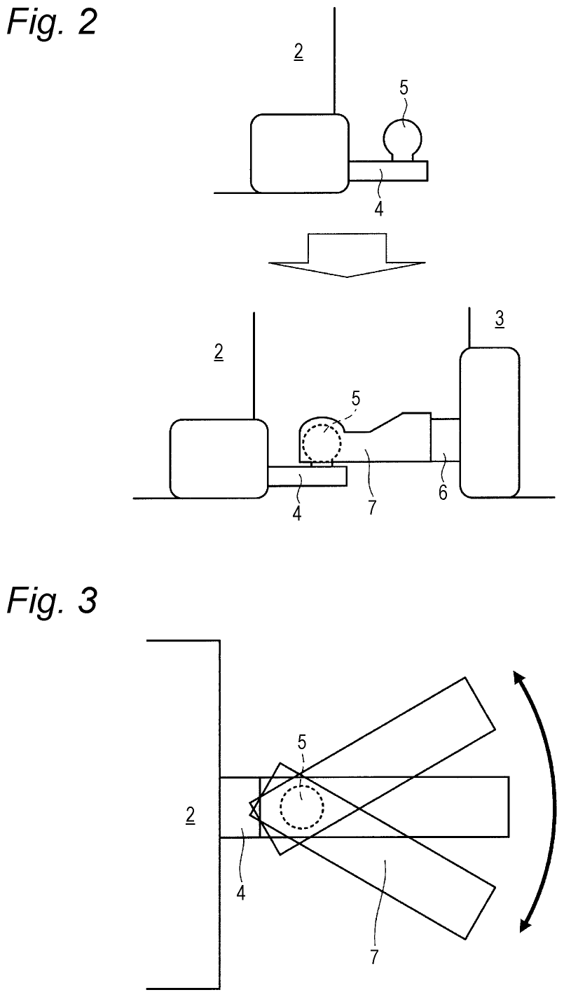

FIG. 2 is an enlarged diagram particularly illustrating a vicinity of the traction device 4.

As illustrated in FIG. 2, the traction device 4 is fixed to, for example, a frame of the towing vehicle 2. As an example, the traction device 4 includes a hitch ball 5 having a spherical distal end portion erected in a vertical direction (vehicle vertical direction), and when the hitch ball 5 is covered with a coupler 7 provided at a distal end portion of a coupling member 6 fixed to the towed vehicle 3, the hitch ball 5 and the coupler 7 are connected to each other, and as a result, the towing vehicle 2 and the towed vehicle 3 are coupled. However, the shapes of the hitch ball 5 and the coupler 7 are not limited to the shapes illustrated in FIG. 2, and may have any shapes as long as coupling the towing vehicle 2 and the towed vehicle 3 is allowed.

In a state where the hitch ball 5 and the coupler 7 are connected to each other, the hitch ball 5 transmits front, rear, left, and right movements to the towed vehicle 3 (coupling member 6) side in accordance with the movement of the towing vehicle 2. In addition, as illustrated in FIG. 3, even when the coupler 7 is connected to the hitch ball 5, the angle of the coupler 7 with respect to the hitch ball 5 is capable of freely (but, there is an upper limit) deviating, and the towed vehicle 3 is swingable (turnable) in the vehicle width direction with respect to the towing vehicle 2.

Incidentally, as illustrated in FIG. 1, a rear camera (imaging device) 9 is installed in a wall portion of a rear hatch on the rear side of the towing vehicle 2. The rear camera 9 is, for example, a digital camera incorporating an imaging element such as a CCD or a CIS. The rear camera 9 is able to output moving image data (captured image data) at a predetermined frame rate. The rear camera 9 has a wide-angle lens or a fisheye lens, the optical axis direction being set obliquely downward, and is able to capture a range of, for example, 140° to 220° in the horizontal direction.

In addition, the range that the rear camera 9 described above is able to capture includes at least the traction device 4 and the hitch ball 5 at the rear end portion of the towing vehicle 2. The captured image data captured by the rear camera 9 is available, for example, to detect a coupled state (for example, a connection angle (hitch angle), whether coupling is established, and the like) between the towing vehicle 2 and the towed vehicle 3. However, as means for detecting the coupling state between the towing vehicle 2 and the towed vehicle 3, a sensor installed in the traction device 4 may be provided instead of the rear camera 9.

Incidentally, the towed vehicle 3 is also called a trailer, and travels while being towed by the towing vehicle 2 described above. Therefore, unlike the towing vehicle 2, the towed vehicle 3 basically does not include an engine or a motor as a drive source. In addition, the towed vehicle 3 is not provided with a steering device (steering system) for changing the direction of the wheels. For example, a camping trailer having a living space therein, a light trailer carrying a car or a ship, and the like correspond to the towed vehicle 3. The towed vehicle 3 includes a main body, a plurality of (two in the present embodiment) trailer wheels, a coupling member 6, and a coupler 7.

Here, as illustrated in FIG. 1, the coupling member 6 is provided at a lower part of a central portion in the vehicle width direction of the main body of the towed vehicle 3, and is arranged to protrude forward (traveling direction) from a front end portion of the main body.

As illustrated in FIG. 2, the coupler 7 is provided at a front end portion of the coupling member 6, and a spherical recess that covers the hitch ball 5 is formed on the coupler 7. When the coupler 7 covers the hitch ball 5, the towed vehicle 3 is coupled to the towing vehicle 2 in a turnable manner as described above (see FIG. 3). Note that the length and the height of the coupling member 6 from the ground surface (that is, the position of the coupler 7 in the towed vehicle 3) vary depending on the type of the towed vehicle 3. However, in the present embodiment, it is assumed that the coupler 7 is located on a position at which the coupler 7 is able to couple to the hitch ball 5 included in the towing vehicle 2.

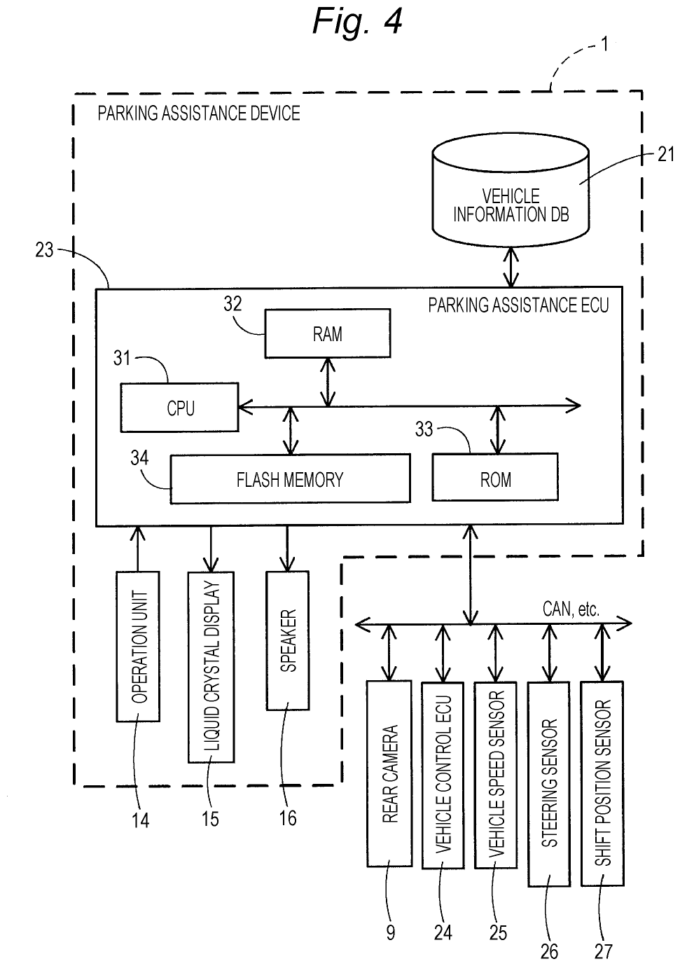

Next, the parking assistance device 1 included in the towing vehicle 2 will be explained. The parking assistance device 1 is a device for assisting a vehicle operation that is performed by a driver when parking to a predetermined parking space in a state where the towing vehicle 2 and the towed vehicle 3 are coupled. FIG. 4 is a block diagram illustrating a configuration of the parking assistance device 1 according to the present embodiment.

As illustrated in FIG. 4, the parking assistance device 1 according to the present embodiment includes an operation unit 14 that receives an operation from an occupant of the towing vehicle 2, a liquid crystal display 15 that displays a traveling trajectory for parking to a parking space and other information related to parking assistance for the occupant of the towing vehicle 2, a speaker 16 that outputs audio guidance related to parking assistance, a vehicle information DB 21 in which various data related to the towing vehicle 2 and the towed vehicle 3 are recorded, and a parking assistance electronic control unit (ECU) 23 that performs various types of arithmetic processing on the basis of the input information. In addition, the parking assistance device 1 is also connected to various sensors such as the rear camera 9 installed on the towing vehicle 2, a vehicle control ECU 24 that performs various controls on the towing vehicle 2, a vehicle speed sensor 25, a steering sensor 26, and a shift position sensor 27 via an in-vehicle network such as a CAN.

The operation unit 14 is provided on an instrument panel or a steering wheel of the towing vehicle 2 to be operated, for example, when operation to shift to a parking assistance mode to be described later is performed or various parameters regarding the towing vehicle 2 and the towed vehicle 3 are input, the operation unit 14 including a plurality of operation switches (not illustrated) such as various keys and buttons.

On the basis of switch signals output by, for example, pressing the respective switches, the parking assistance ECU 23 performs control to execute various operations corresponding to the switch signals. Note that the operation unit 14 may have a touch panel provided on the front surface of the liquid crystal display 15. In addition, a microphone and a voice recognition device may be provided.

The liquid crystal display 15 is provided on the instrument panel of the towing vehicle 2, and displays, for example, a traveling trajectory for parking at the time of shifting to the parking assistance mode for assisting parking in a state where the towing vehicle 2 is connected to the towed vehicle 3. In addition, in a case where the parking operation is not automatically performed but is performed by a user, a steering operating instruction for traveling along the traveling trajectory and brake, accelerator, and shift-position operating instructions are also displayed. Note that the liquid crystal display 15 may also be used for a navigation device.

In addition, the speaker 16 outputs voice guidance or the like for guiding the parking operation at the time of shifting to the parking assistance mode based on an instruction from the parking assistance ECU 23. Note that the speaker 16 may also be used for the navigation device.

In addition, the vehicle information DB 21 is storage means that stores various types of information regarding the towing vehicle 2 and the towed vehicle 3. For example, the installation position (height from the ground surface, position in the left-right direction, distance from the rear end of vehicle) of the hitch ball 5, the total length, the vehicle width, the wheelbase, the minimum turning radius, and the like are stored for the towing vehicle 2. In addition, the distance from the rear axle of the towing vehicle 2 to the coupling point (the position of the hitch ball 5) between the towing vehicle 2 and the towed vehicle 3 is also stored. Incidentally, the installation position (height from the ground surface, position in the left-right direction, distance from the rear end of vehicle) of the coupler 7, the total length, the vehicle width, the wheelbase, the minimum turning radius, and the like are stored for the towed vehicle 3. In addition, the distance (corresponding to the trailer wheel base) from the turning center of the towed vehicle 3 to the coupling point (the position of the hitch ball 5) between the towing vehicle 2 and the towed vehicle 3 is also stored. Note that, when the towed vehicle 3 has one axle (two wheels), the center of the axle becomes the turning center of the towed vehicle 3. Incidentally, when the towed vehicle 3 has two axles (four wheels), the turning center exists between the two axles. These pieces of information may be input in advance by an occupant or a person on a vehicle manufacturer side using the operation unit 14, or values detected by the rear camera 9 and various sensors may be automatically input as that information. Note that the towed vehicle 3 to be towed is not necessarily fixed, so that the parameters described above need to be changed when the towed vehicle 3 to be towed is changed. As a storage medium of the vehicle information DB 21, for example, a memory card can be used. Furthermore, a storage medium may be provided in a storage area (for example, RAM or flash memory) in the parking assistance ECU 23.

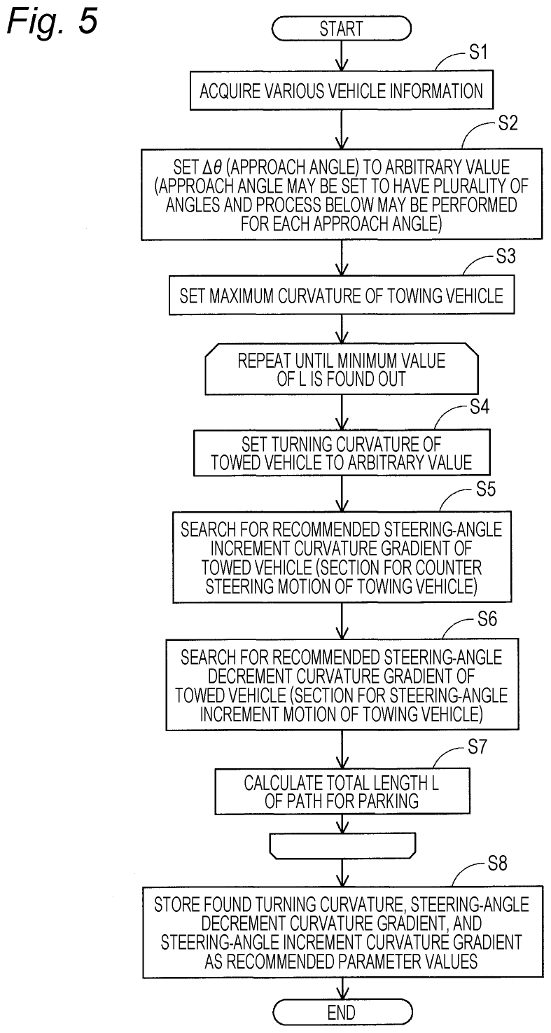

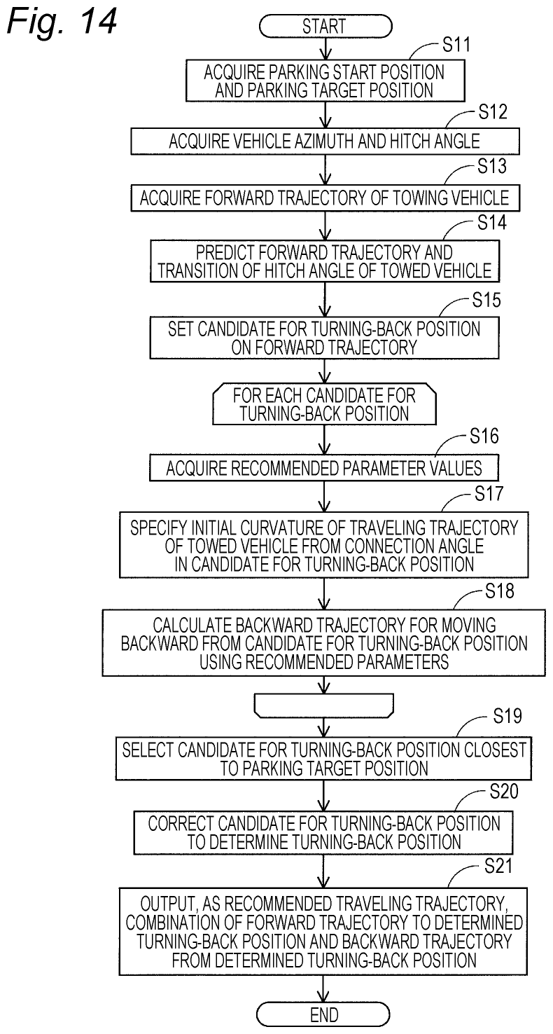

Incidentally, the parking assistance ECU 23 is an electronic control unit that performs overall control of the parking assistance device 1, and includes a CPU 31 as an arithmetic unit and a control device, and internal storage devices such as a RAM 32 that is used as a working memory when the CPU 31 performs various arithmetic processing and stores path data and the like when a path is searched for, a ROM 33 in which a parameter specifying processing program (see FIG. 5), a parking assistance program (see FIG. 14), and the like described later are recorded in addition to a program for control, and a flash memory 34 that stores the program read from the ROM 33. Note that the parking assistance ECU 23 includes various control units as processing algorithms. For example, a maximum value setting unit sets the maximum value of the curvature or the steering angle allowed for the traveling trajectory of the towing vehicle 2. A trailer wheel base acquisition unit acquires the distance from the turning center of the towed vehicle 3 to the coupling point between the towing vehicle 2 and the towed vehicle 3 as the trailer wheel base. A coupling distance acquisition unit acquires the coupling distance that is the distance from the rear axle of the towing vehicle 2 to the coupling point between the towing vehicle 2 and the towed vehicle 3. A parameter specification unit specifies respective recommended values of the predetermined turning curvature X and the steering-angle decrement curvature gradient β in the traveling trajectory during parking of the towed vehicle 3, based on the trailer wheel base and the coupling distance on the condition that the curvature or the steering angle for the traveling trajectory of the towing vehicle 2 does not exceed the maximum value.

In addition, the vehicle control ECU 24 is an electronic control unit that performs control of the towing vehicle 2. In addition, the vehicle control ECU 24 is connected to each drive unit of the vehicle such as a steering wheel, a brake, an accelerator, and a transmission, and in the present embodiment, for example, at the time of shifting to a parking assistance mode for assisting parking to a parking space described later, automatic driving assistance of the towing vehicle 2 is able to be performed by controlling each drive unit. Specifically, the parking assistance ECU 23 transmits various types of assistance information regarding automatic driving assistance generated by the parking assistance device 1 to the vehicle control ECU 24 via the CAN when the parking assistance mode is executed. The vehicle control ECU 24 performs automatic driving assistance after the start of traveling by using the received various types of assistance information. Examples of the assistance information include a traveling trajectory on which the towing vehicle 2 and the towed vehicle 3 are recommended to travel, and information indicating a vehicle speed and a steering angle when the towing vehicle 2 and the towed vehicle 3 travel along the traveling trajectory. Note that, in the automatic driving assistance, only the steering operation may be automatically performed, or the driving source, the brake, and the transmission may be automatically controlled. Incidentally, it is not essential to equip the towing vehicle 2 with the automatic driving assistance described above, and the towing vehicle 2 may be a vehicle that allows only manual driving. In this case, at the time of shifting to the parking assistance mode, steering operating guidance and brake, accelerator, and shift-position operating guidance for traveling along a recommended traveling trajectory are performed, instead of the automatic driving assistance described above.

In addition, the vehicle speed sensor 25 includes an active wheel speed sensor attached to a wheel of the towing vehicle 2, detects the rotation speed of the wheel, and outputs a speed signal. In addition, the steering sensor 26 is attached inside the steering device, detects a steering angle when the steering wheel is steered, and outputs a steering angle signal. Furthermore, the shift position sensor 27 is built in a shift lever, and detects which one of “P (parking)”, “N (neutral)”, “R (reverse)”, “D (drive)”, “2 (second gear)”, and “L (low gear)” the shift position is.

The parking assistance ECU 23 is able to acquire the current vehicle speed, travel distance, steering angle, shift position, and the like of the towing vehicle 2 based on the output signals from the various sensors described above.

Next, a parameter specification processing program executed by the parking assistance ECU 23 in the parking assistance device 1 having the configuration described above will be explained with reference to FIG. 5. FIG. 5 is a flowchart of the parameter specification processing program according to the present embodiment. Here, the parameter specifying processing program is a program that is executed when a predetermined initial setting operation is received in the operation unit 14 in a state where an accessory (ACC) power supply of the towing vehicle 2 is turned on, the program deriving recommended values of parameters used to generate a traveling trajectory when parking is performed. Note that the program illustrated in the flowchart in FIG. 5 below is stored in the RAM 32 or the ROM 33 included in the parking assistance device 1, and is executed by the CPU 31.

First, in step (hereinafter abbreviated as S) 1, the CPU 31 acquires information on the towing vehicle 2 and the towed vehicle 3 from the vehicle information DB 21. Note that various types of information on the towing vehicle 2 and the towed vehicle 3 are stored in the vehicle information DB 21. In particular, at S1 above, at least “the minimum turning radius” and “the distance (hereinafter referred to as coupling distance) from the rear axle of the towing vehicle 2 to the coupling point (the position of the hitch ball 5) between the towing vehicle 2 and the towed vehicle 3” for the towing vehicle 2 and “the distance (hereinafter referred to as trailer wheel base) from the coupling point between the towing vehicle 2 and the towed vehicle 3 to a front axle of the towed vehicle 3” for the towed vehicle 3 are acquired.

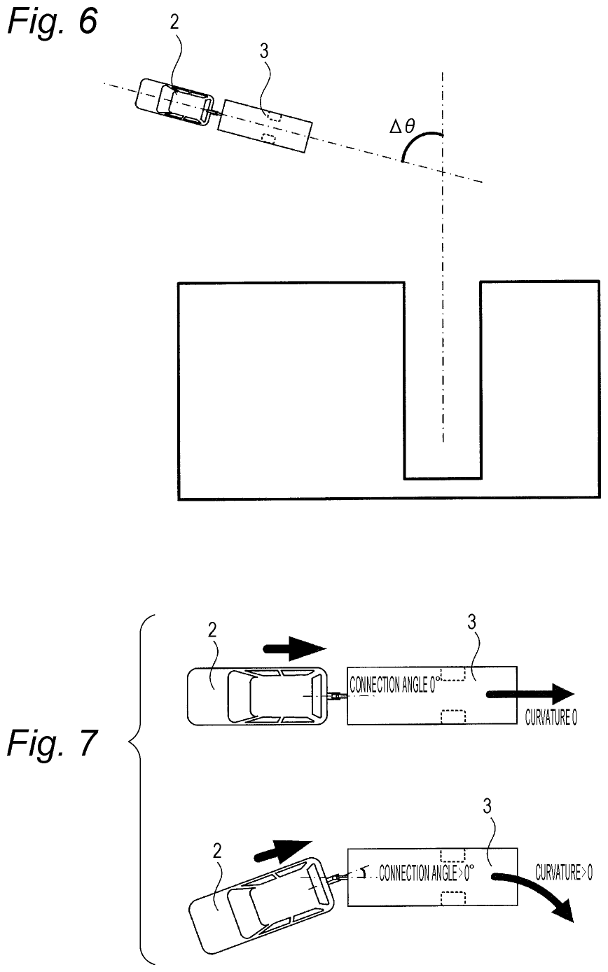

Next, at S2, the CPU 31 sets a virtual parking situation as illustrated in FIG. 6 in order to derive the recommended values of the parameters. In particular, at S2 above, an arbitrary value is set as the angle of approach Δθ to the parking space (also corresponding to the angle amount required to turn in order to enter the parking space). Note that the approach angle Δθ may be set to any of 30 degrees, 60 degrees, and 90 degrees, for example. In addition, a plurality of angles may be set as the approach angle Δθ. In this case, the following processing is executed for each approach angle Δθ having been set, and a parameter is calculated for each Δθ.

Subsequently, at S3, the CPU 31 sets the maximum curvature allowed for the traveling trajectory of the towing vehicle 2 based on the minimum turning radius of the towing vehicle 2 acquired at S1 above. In particular, as the maximum curvature, a first maximum curvature allowed in a traveling trajectory on which the towing vehicle 2 turns in the same direction as the towed vehicle 3 (the right direction along the backward direction in the example illustrated in FIG. 6) and a second maximum curvature allowed in a traveling trajectory on which the towing vehicle 2 turns in a direction different from the towed vehicle 3 (the left direction along the backward direction in the example illustrated in FIG. 6) are respectively set, and furthermore, the second maximum curvature has a value smaller than the first maximum curvature. For example, the first maximum curvature is a curvature of a trajectory drawn when the towing vehicle 2 turns with the minimum turning radius, and the second maximum curvature is three quarters of the first maximum curvature. As an example, the first maximum curvature is 0.2 [1/m], and the second maximum curvature is 0.15 [1/m].

Thereafter, at S4, the CPU 31 sets the turning curvature of the towed vehicle 3 to an arbitrary value when parking is performed in the virtual parking situation set at S2 above. Note that the turning curvature corresponds to the maximum value (maximum curvature) of the curvature of the traveling trajectory of the towed vehicle 3.

Here, regarding the curvature of the traveling trajectory drawn by the towed vehicle 3 when the towing vehicle 2 towing the towed vehicle 3 moves backward, the towed vehicle 3 does not have a steering device, so that the curvature of the traveling trajectory of the towed vehicle 3 is mainly determined based on the connection angle between the towing vehicle 2 and the towed vehicle 3 as illustrated in FIG. 7. That is, as illustrated in the upper diagram of FIG. 7, when the connection angle between the towing vehicle 2 and the towed vehicle 3 is 0 degrees (located on a straight line), the curvature of the traveling trajectory that is drawn when the towed vehicle 3 is pushed by the towing vehicle 2 moving backward is zero. Incidentally, as illustrated in the lower diagram of FIG. 7, when the connection angle between the towing vehicle 2 and the towed vehicle 3 is larger than 0 degrees, the curvature of the traveling trajectory that is drawn when the towed vehicle 3 is pushed by the towing vehicle 2 moving backward is larger than zero. As the connection angle between the towing vehicle 2 and the towed vehicle 3 increases, the curvature of the traveling trajectory of the towed vehicle 3 increases (the turning radius decreases).

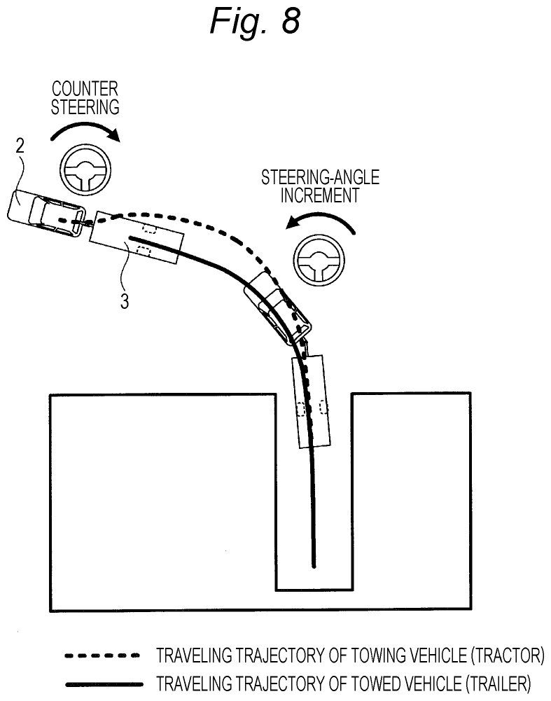

When the towing vehicle 2 towing the towed vehicle 3 moves backward and performs parking, it is important to increase the curvature of the traveling trajectory drawn by the towed vehicle 3, in as short a time as possible to shorten the total length of the path for parking. Therefore, as illustrated in FIG. 8, first, immediately after the start of backward movement, the towing vehicle 2 generally performs a counter steering motion of intentionally steering in a direction opposite (the right direction in FIG. 8) to the original turning direction (it is the left direction in FIG. 8 because a driver desires to turn to the left rear as viewed from the driver), and then steers in the original turning direction. In contrast, it is necessary to bring the connection angle between the towing vehicle 2 and the towed vehicle 3 close to 0 degrees in a state of approaching the parking target position. However, in order to shorten the total length of the path for parking, it is effective to maintain a state where the curvature is as large as possible until the end and quickly reduce the curvature at the end, instead of gradually reducing the curvature. Therefore, it is general to perform the steering-angle increment motion to increase steering in the turning direction at the end of turning.

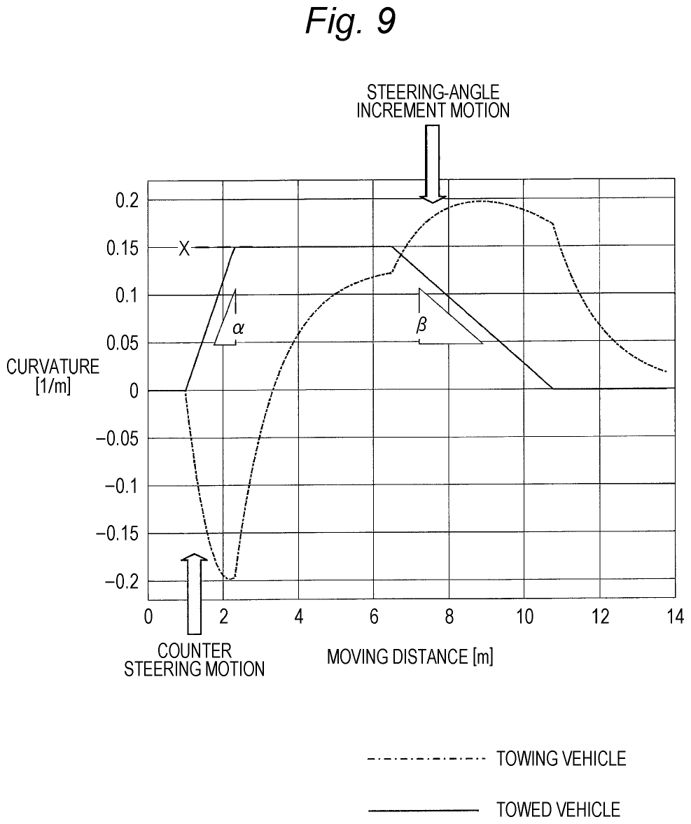

When the towing vehicle 2 described above performs the counter steering motion and the steering-angle increment motion, the curvature of each of the traveling trajectories of the towing vehicle 2 and the towed vehicle 3 exhibits transition as an example illustrated in FIG. 9. That is, the counter steering motion is performed in the towing vehicle 2, so that the curvature of the traveling trajectory of the towed vehicle 3 increases from zero, which is the initial curvature at the time point of starting backward movement, to the turning curvature X at a predetermined increase rate (gradient) a (first section). The steering-angle increment motion is performed in the towing vehicle 2 after the towing vehicle 2 moves backward by a predetermined distance while maintaining the turning curvature, so that the curvature of the traveling trajectory of the towed vehicle 3 decreases from the turning curvature X to zero at a predetermined decrease rate (gradient) β (second section). Note that, in the example illustrated in FIG. 9, α and β are constant values with respect to the moving distance (linear graphs), but may be values that deviate with respect to the moving distance (curve graphs). In addition, in the virtual parking situation set at S2 above, it is assumed that the connection angle between the towing vehicle 2 and the towed vehicle 3 is 0 degrees (located on a straight line) at the time point of starting backward movement. However, if a situation is assumed in which the connection angle between the towing vehicle 2 and the towed vehicle 3 is other than 0 degrees at the time point of starting backward movement, the initial value of the curvature of the traveling trajectory of the towed vehicle 3 is other than zero.

At S4 above, in order to search for a recommended value of the turning curvature X illustrated in FIG. 9, the CPU 31 first temporarily sets an arbitrary value as the turning curvature X. Note that, as will be described later, it is determined whether the temporarily set turning curvature is a recommended value by reference to the entire length L of the path for parking when the temporarily set turning curvature X that has finally been set at S4 above is used.

Subsequently, at S5, the CPU 31 searches for a recommended steering-angle increment curvature gradient of the towed vehicle 3 when parking is performed in the virtual parking situation set at S2 above. Note that the steering-angle increment curvature gradient is an increase rate (an increase value of the curvature per unit travel distance) when the curvature of the traveling trajectory of the towed vehicle 3 is increased by the counter steering motion of the towing vehicle 2, and is a value of a illustrated in FIG. 9.

Hereinafter, a method of searching for a recommended value of the steering-angle increment curvature gradient α will be explained.

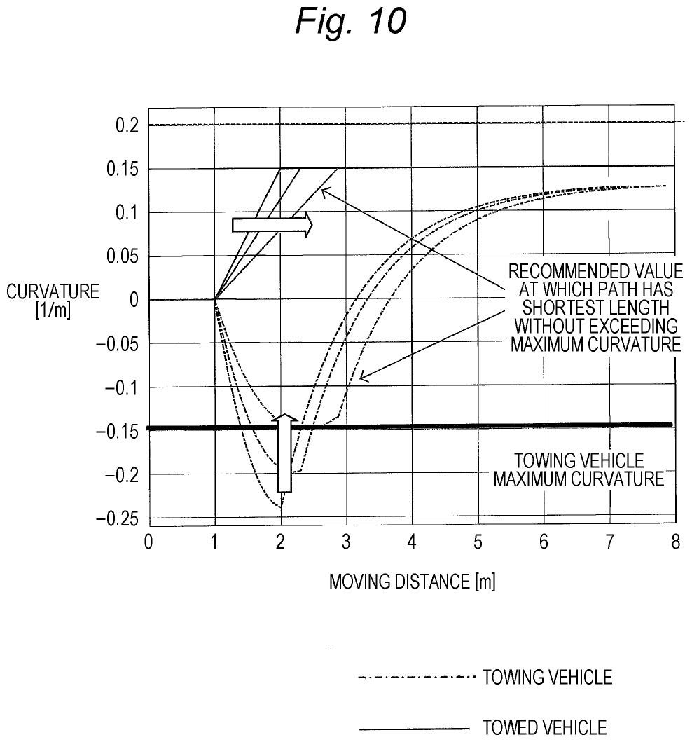

FIG. 10 is a diagram illustrating a relationship between the curvature of the traveling trajectory of the towing vehicle 2 in the counter steering motion of the towing vehicle 2 and the steering-angle increment curvature gradient α of the traveling trajectory of the towed vehicle 3. Note that the curvature of each of the traveling trajectories illustrated in FIG. 10 can be derived as follows: calculate each of possible traveling trajectories of the towing vehicle 2 and the towed vehicle 3 by using the trailer wheel base that is the distance from the turning center of the towed vehicle 3 to the coupling point and the coupling distance that is the distance from the rear axle of the towing vehicle 2 to the coupling point between the towing vehicle 2 and the towed vehicle 3, the trailer wheel base and the coupling distance having been acquired at S1 above with respect to the virtual parking situation set at S2 above; and then extract the curvature from each of the calculated traveling trajectories. As illustrated in FIG. 10, the larger the curvature in the negative direction at the time of the counter steering motion of the towing vehicle 2, the larger the steering-angle increment curvature gradient α of the traveling trajectory of the towed vehicle 3. In contrast, it is estimated that the distance required for the towed vehicle 3 to turn becomes shorter as the steering-angle increment curvature gradient α becomes larger, and the total length of the path for parking becomes shorter. Therefore, as illustrated in FIG. 10, the curvature of the towing vehicle 2 in the counter steering motion is deviated stepwise, and the maximum value of the steering-angle increment curvature gradient α is searched for on the condition that the traveling trajectory of the towing vehicle 2 does not exceed the maximum curvature set at S3 above. Specifically, in a case where the traveling trajectory of the towing vehicle 2 has the maximum curvature set at S3 above (for example, −0.15 [1/m] in the example illustrated in FIG. 10),
the steering-angle increment curvature gradient α of the traveling trajectory of the towed vehicle 3 corresponding to the case is a recommended value. When a steering angular velocity limit value is exceeded during backward travel at an assumed backward vehicle speed (for example, 4 km/h) using the steering-angle increment curvature gradient α searched for, the steering-angle increment curvature gradient α is decreased to a value not exceeding the steering angular velocity limit value.

Subsequently, at S6, the CPU 31 searches for a recommended steering-angle decrement curvature gradient of the towed vehicle 3 when parking is performed in the virtual parking situation set at S2 above. Note that the steering-angle decrement curvature gradient is a decrease rate (a decrease value of the curvature per unit travel distance) when the curvature of the traveling trajectory of the towed vehicle 3 is decreased by the steering-angle increment motion of the towing vehicle 2, and is a value of β illustrated in FIG. 9.

Hereinafter, a method of searching for a recommended value of the steering-angle decrement curvature gradient β will be explained.

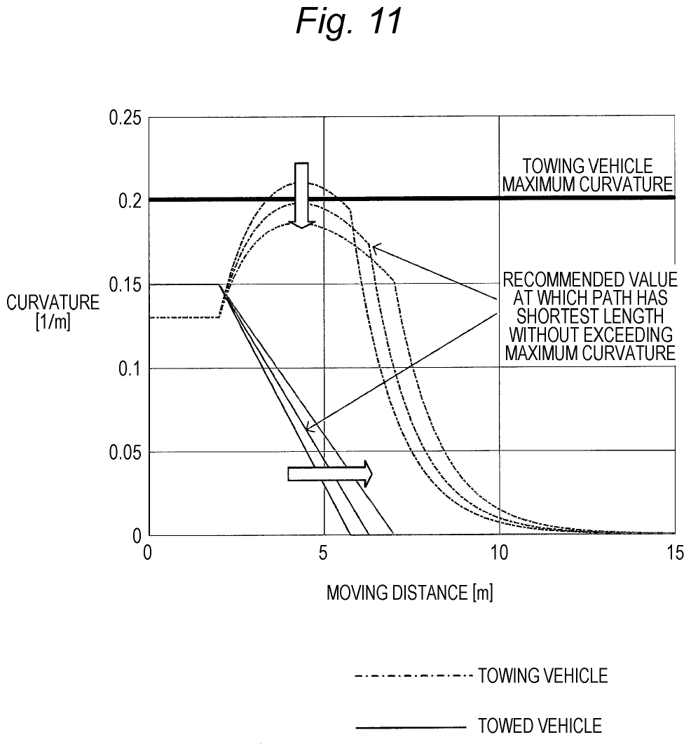

FIG. 11 is a diagram illustrating a relationship between the curvature of the traveling trajectory of the towing vehicle 2 in the steering-angle increment motion of the towing vehicle 2 and the steering-angle decrement curvature gradient β of the traveling trajectory of the towed vehicle 3. Note that the curvature of each of the traveling trajectories illustrated in FIG. 11 can be derived by calculating each of possible traveling trajectories of the towing vehicle 2 and the towed vehicle 3 using: the trailer wheel base that is the distance from the turning center of the towed vehicle 3 to the coupling point acquired at S1 above with respect to the virtual parking situation set at S2 above; and the distance from the rear axle of the towing vehicle 2 to the coupling point between the towing vehicle 2 and the towed vehicle 3 and by then extracting the curvature from the calculated traveling trajectory. As illustrated in FIG. 11, the larger the curvature in the positive direction at the time of the steering-angle increment motion of the towing vehicle 2, the larger the steering-angle decrement curvature gradient β of the traveling trajectory of the towed vehicle 3. In contrast, it is estimated that the distance required for the towed vehicle 3 to turn becomes shorter as the steering-angle decrement curvature gradient β becomes larger, and the total length of the path for parking becomes shorter. Therefore, as illustrated in FIG. 11, the curvature of the towing vehicle 2 in the steering-angle increment motion is deviated stepwise, and the maximum value of the steering-angle decrement curvature gradient β is searched for on the condition that the traveling trajectory of the towing vehicle 2 does not exceed the maximum curvature set at S3 above. Specifically, in a case where the traveling trajectory of the towing vehicle 2 has the maximum curvature set at S3 above (for example, +0.2 [1/m] in the example illustrated in FIG. 11), the steering-angle decrement curvature gradient β of the traveling trajectory of the towed vehicle 3 corresponding to the case is a recommended value. When a steering angular velocity limit value is exceeded during backward travel at an assumed backward vehicle speed (for example, 4 km/h) using the steering-angle decrement curvature gradient β searched for, the steering-angle decrement curvature gradient β is decreased to a value not exceeding the steering angular velocity limit value.

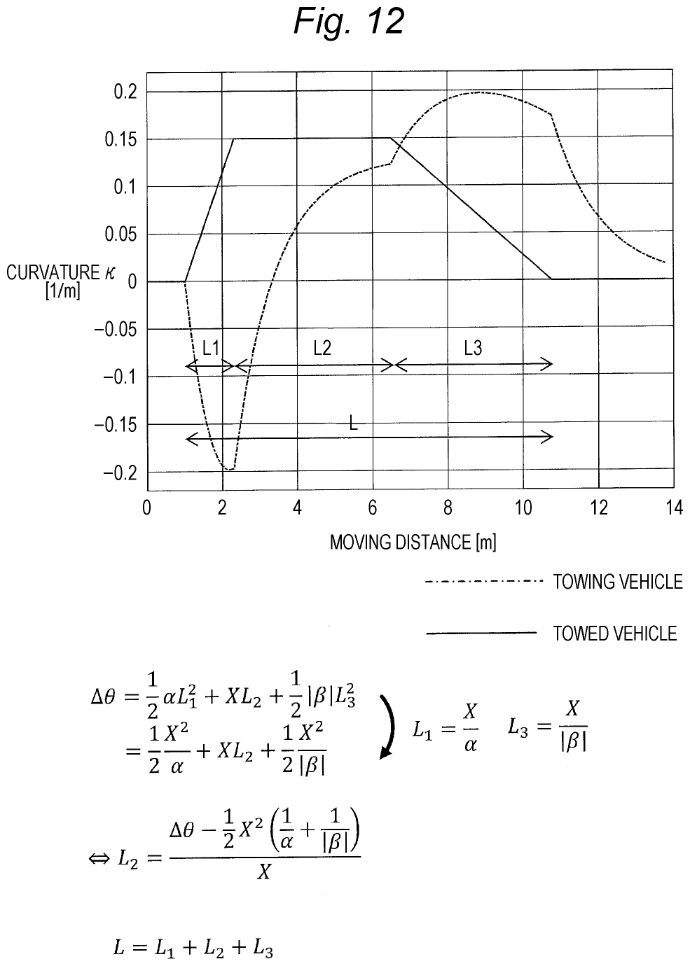

Then, at S7, the CPU 31 calculates the total length L of the path for parking in order to determine whether each value temporarily set and searched for at S4 to S6 above is a recommended value. Note that L may be calculated based on either the traveling trajectory of the towing vehicle 2 or the traveling trajectory of the towed vehicle 3. For example, when the calculation is based on the traveling trajectory of the towed vehicle 3, L is calculated by the formulae illustrated in FIG. 12.

Similarly, the value of the turning curvature X arbitrarily set at S4 above is appropriately changed, and the processing of S4 to S7 is repeatedly performed. The recommended values of the turning curvature X, the steering-angle increment curvature gradient α, and the steering-angle decrement curvature gradient β are respectively specified with priority given to shortening of the total length L of the path for parking. Specifically, a combination of the turning curvature X, the steering-angle increment curvature gradient α, and the steering-angle decrement curvature gradient β, making L calculated at S7 above the minimum, is searched for, and after the combination of the turning curvature X, the steering-angle increment curvature gradient α, and the steering-angle decrement curvature gradient β, making L the minimum, is specified, each specified value is stored in the flash memory 34 or the like as a value recommended for use in generation of the traveling trajectory (S8).

Note that, as the trailer wheel base that is the distance from the turning center of the towed vehicle 3 to the coupling point used to derive the recommended parameters in the present embodiment, the trailer wheel base that is the distance from the turning center of the towed vehicle 3, which is currently coupled, to the coupling point is used, but a virtual trailer wheel base may be used. For example, the trailer wheel base may be set to 2 m, 2.5 m, 3 m, 3.5 m, and 4 m, and the above-described parameter specifying processing program may be executed for each trailer wheel base to derive the recommended parameters. Accordingly, it is not necessary to execute the above-described parameter specifying processing program every time the coupled towed vehicle 3 is changed, and it is possible to easily specify parameters recommended for the towed vehicle 3 to be coupled.

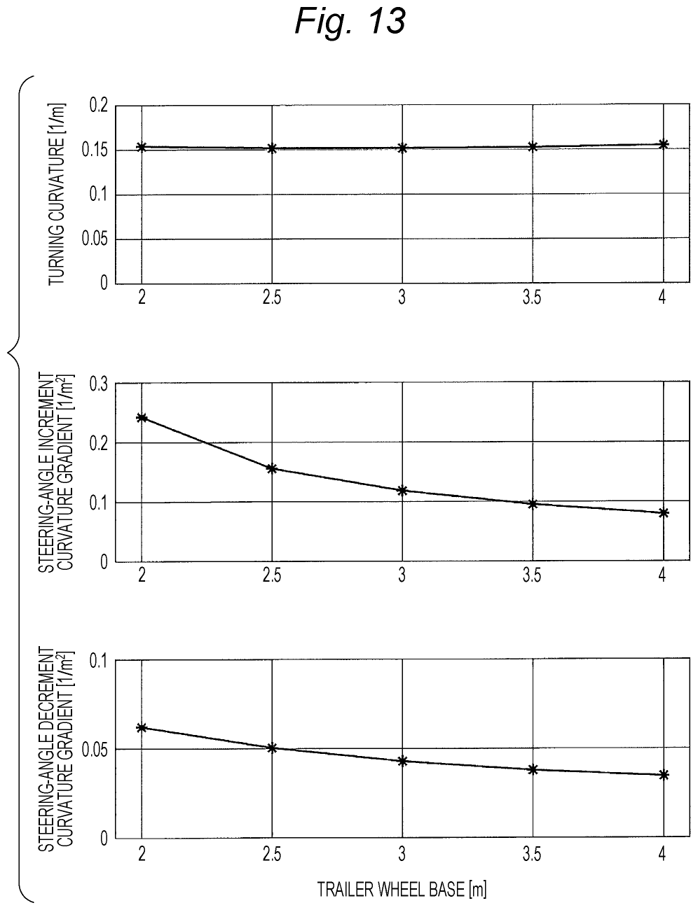

Here, FIG. 13 is a diagram illustrating a relationship between the trailer wheel base and the parameters derived at S8 above. As illustrated in FIG. 13, in a range where the trailer wheel base of the towed vehicle 3 is 2 m to 4 m, it is found that the influence of the trailer wheel base of the towed vehicle 3 is small on the recommended turning curvature X, but smaller values are derived for the recommended steering-angle increment curvature gradient α and the recommended steering-angle decrement curvature gradient β as the trailer wheel base increases.

As illustrated in FIG. 13, by performing linear interpolation, it is possible to specify recommended parameters for trailer wheel bases other than 2 m, 2.5 m, 3 m, 3.5 m, and 4 m.

The same applies to the coupling distance. For example, in the present embodiment described above, the distance from the rear axle of the towing vehicle 2 to the coupling point of the traction device 4 provided to the towing vehicle 2 at the present time is used, but a virtual coupling distance may be used similarly to the trailer wheel base described above. For example, the coupling distance may be set to 2 m, 2.5 m, 3 m, 3.5 m, and 4 m, and the above-described parameter specifying processing program may be executed for each coupling distance to derive the recommended parameters. Accordingly, it is not necessary to execute the above-described parameter specifying processing program every time the traction device 4 provided to the towing vehicle 2 is changed, and it is possible to easily specify parameters recommended for the traction device 4 provided to the towing vehicle 2.

In addition, at S8 above, the parameters recommended for a parking situation in which parking is performed by turning at one approach angle Δθ (for example, 60 degrees) set at S2 above are derived, but the parameter having been derived is also available as parameters recommended for a parking situation in which parking is performed at an approach angle (for example, 90 degrees or 45 degrees) other than the approach angle Δθ set at S2 above. However, a plurality of angles may be set as the approach angle Δθ, and recommended parameters may be derived for each Δθ.

The CPU 31 uses each of the recommended values of the turning curvature X, the steering-angle increment curvature gradient α, and the steering-angle decrement curvature gradient β derived at S8 above to generate the traveling trajectory of the towing vehicle 2 when parking is actually performed as described later.

Next, a parking assistance processing program executed by the parking assistance ECU 23 in the parking assistance device 1 having the configuration described above will be explained with reference to FIG. 14. FIG. 14 is a flowchart of the parking assistance program according to the present embodiment. Here, the parking assistance processing program is a program that is executed after the ACC power supply of the towing vehicle 2 is turned on and when a driver of the towing vehicle 2 operates the operation unit 14 to select the shift to the parking assistance mode, the parking assistance processing program supporting the parking operation performed by the driver when performing parking in a state where the towing vehicle 2 is coupled to the towed vehicle 3. Note that the program illustrated in the flowchart in FIG. 14 below is stored in the RAM 32 or the ROM 33 included in the parking assistance device 1, and is executed by the CPU 31.

First, at S11, the CPU 31 acquires the parking start position and the parking target position. Basically, the current position of the towing vehicle 2 and the towed vehicle 3 is the parking start position. However, when it is difficult to park from the current position to the parking target position, the parking start position may be set at a position different from the current position, and guidance to the parking start position may be performed. Incidentally, as for the parking target position, for example, a position in which the user wants to park the vehicles may be designated from an image around the towing vehicle 2 displayed on the liquid crystal display 15, and the designated position may be set as the parking target position, or a parking space around the towing vehicle 2 may be detected by a camera or a sensor, and the detected parking space may be set as the parking target position.

Next, at S12, the CPU 31 acquires the azimuth of the towing vehicle 2 and the towed vehicle 3 and the connection angle (hitch angle) between the towing vehicle 2 and the towed vehicle 3 at the parking start position. As described above, the current positions of the towing vehicle 2 and the towed vehicle 3 are basically the parking start position, so that the current azimuth direction of and connection angle between the towing vehicle 2 and the towed vehicle 3 are acquired at S12 above. Note that the connection angle can be specified from, for example, an image captured by the rear camera 9.

Subsequently, at S13, the CPU 31 acquires the forward trajectory of the towing vehicle 2 that advances while turning in a direction away from the parking target position from the parking start position acquired at S11 above to the azimuth of the towing vehicle 2 acquired at S12 above. Here, in particular, the traveling trajectory in a case where backward parking is performed includes a forward section in which the vehicle moves forward first to a turning-back position suitable for entering a parking target position that is a parking target such as a parking space, and a backward section in which the vehicle is switched to backward movement at the turning-back position and moves backward to the parking target position. Hereinafter, the traveling trajectory in the forward section is referred to as forward trajectory, and the traveling trajectory in the backward section is referred to as backward trajectory. The forward trajectory of the towing vehicle 2 is basically a traveling trajectory having a fixed shape prepared in advance, but in a case where the size of a peripheral empty space is insufficient or the like, the prepared forward trajectory may be corrected for use.

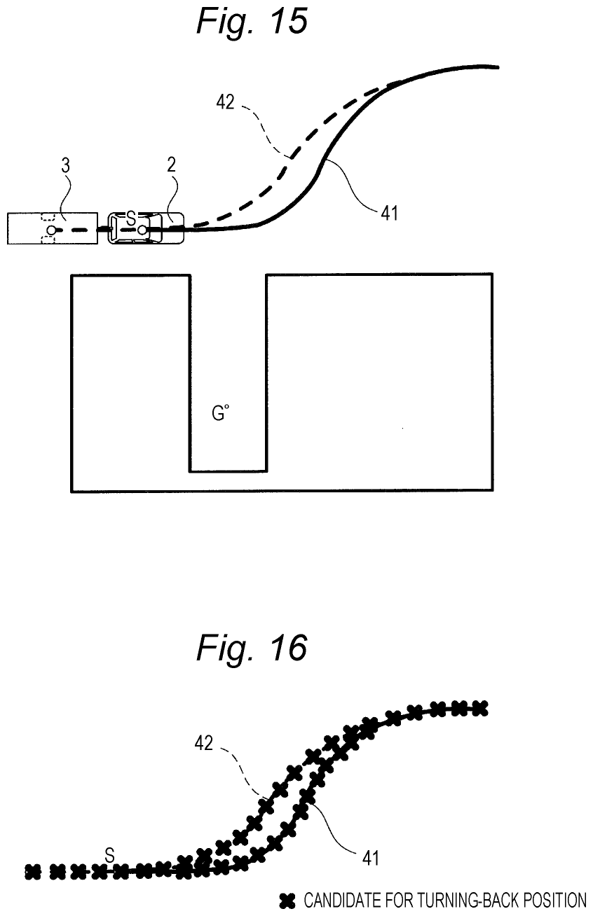

Here, FIG. 15 is a diagram illustrating an example of a forward trajectory of the towing vehicle 2 acquired at S13 above. As illustrated in FIG. 15, a forward trajectory 41 of the towing vehicle 2 is a trajectory to which a plurality of clothoid curves are connected and along which the towing vehicle 2 obliquely moves forward. For example, the forward trajectory 41 illustrated in FIG. 15 is a combination of a first clothoid curve along which the towing vehicle 2 advances from the parking start position S while gradually turning the steering wheel in the left direction (that is, the curvature is being gradually changed so as to be large) and a second clothoid curve along which the towing vehicle 2 advances while gradually turning back the steering wheel toward the straight direction (that is, the curvature is being gradually changed so as to be small).

Note that the lateral movement direction is a direction away from a parking target position G, and the length of the forward trajectory is that of a trajectory allowing the towing vehicle 2 to move to at least a position farther than the parking target position G.

Then, at S14, the CPU 31 predicts the traveling trajectory drawn by the towed vehicle 3 and the transition of the connection angle (hitch angle) when the towing vehicle 2 moves along the forward trajectory acquired at S13, and acquires the predicted traveling trajectory and transition of the connection angle as the traveling trajectory of the towed vehicle 3 and the transition of the connection angle in traveling along the forward trajectory. Note that the prediction of the traveling trajectory of the towed vehicle 3 and the transition of the connection angle is performed based on various types of information (for example, the distance from the rear axle of the towing vehicle 2 to the coupling point (the position of the hitch ball 5) between the towing vehicle 2 and the towed vehicle 3, the trailer wheel base, and the like) stored in the vehicle information DB 21 and the azimuth of the towed vehicle 3 and the connection angle acquired at S12 above. FIG. 15 also illustrates an example of a forward trajectory 42 of the towed vehicle 3 predicted in a case where the towing vehicle 2 moves along the forward trajectory 41.

Next, at S15, the CPU 31 sets a candidate for turning-back position to be a candidate for position at which the towing vehicle 2 and the towed vehicle 3 perform turning-back (switching from forward movement to backward movement) on each of the forward trajectories acquired at S13 and S14. Note that, as illustrated in FIG. 16, a plurality of candidates for turning-back position are set from the start point to the end point of the forward trajectory at predetermined distance intervals (for example, an interval of 1 m or 50 cm). Note that the interval and the number of candidates for turning-back position to be set can be changed as appropriate. In addition, the turning-back position candidate may be set in a section not from the start point to the end point of the forward trajectory but only in a range (near the center) that is particularly likely to be the turning-back position.

Processing from S16 to S18 described below is executed for each candidate for turning-back position set at S15 above, and the backward trajectories of the towing vehicle 2 and the towed vehicle 3 in a case where it is assumed that backward movement is started from a candidate for turning-back position on the forward trajectory set at S15 above are calculated for each of the candidates as follows.

After the processing from S16 to S18 is executed for all the candidates for turning-back position set at S15 above, the step proceeds to S19.

Here, as explained in the parameter specifying processing program (FIG. 5) described above, when the towing vehicle 2 towing the towed vehicle 3 moves backward and performs parking, the towing vehicle 2 performs the counter steering motion and the steering-angle increment motion (FIG. 8). The towing vehicle 2 described above performs the counter steering motion and the steering-angle increment motion, and thereby the curvature of each of the traveling trajectories of the towing vehicle 2 and the towed vehicle 3 exhibits transition as an example illustrated in FIG. 9. That is, the counter steering motion is performed in the towing vehicle 2, so that the curvature of the traveling trajectory of the towed vehicle 3 increases from the initial curvature (zero in FIG. 9) at the time point of starting backward movement, to the turning curvature X at a predetermined increase rate (gradient) a (first section). The steering-angle increment motion is performed in the towing vehicle 2 after the towing vehicle 2 moves backward by a predetermined distance while maintaining the turning curvature, so that the curvature of the traveling trajectory of the towed vehicle 3 decreases from the turning curvature X to zero at a predetermined decrease rate (gradient) β (second section).

In the parameter specifying processing program (FIG. 5) described above, the recommended values of the turning curvature X, the steering-angle increment curvature gradient α, and the steering-angle decrement curvature gradient β are derived, and first, at S16, the CPU 31 reads and acquires these recommended values from the flash memory 34.

Subsequently, at S17, the CPU 31 specifies the connection angle between the towing vehicle 2 and the towed vehicle 3 at the time of being positioned on the candidate for turning-back position, based on the transition of the connection angle (hitch angle) between the towing vehicle 2 and the towed vehicle 3 when moving forward along the forward trajectory predicted at S14.

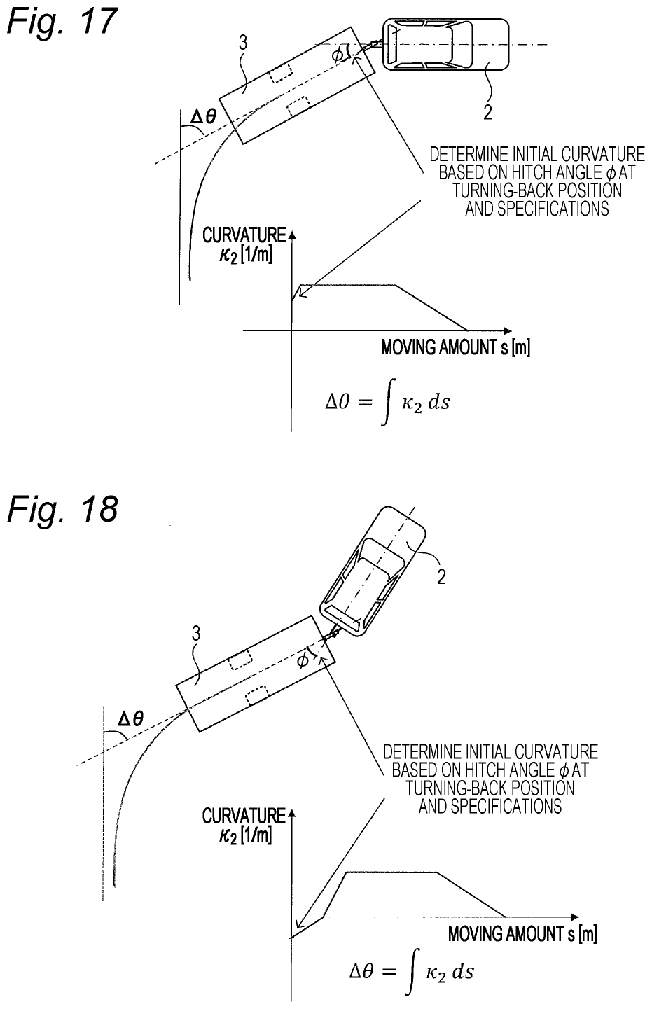

Here, the initial curvature of the traveling trajectory of the towed vehicle 3 is determined according to the connection angle between the towing vehicle 2 and the towed vehicle 3 at the time point of starting backward movement, that is, at the time point of turning back. Specifically, as illustrated in FIG. 17, when the towing vehicle 2 faces the parking target position side with respect to the traveling direction of the towed vehicle 3 at the time point of turning back, the initial curvature is larger than zero (trajectory along which turning is started in the same direction as the turning direction to the parking target position), and as illustrated in FIG. 18, when the towing vehicle 2 faces the opposite side to the parking target position with respect to the traveling direction of the towed vehicle 3 at the time point of turning back, the initial curvature is smaller than zero (trajectory along which turning is started in the opposite direction to the turning direction to the parking target position). At S17, the initial curvature described above is specified based on the connection angle between the towing vehicle 2 and the towed vehicle 3 at the time point of being positioned on the candidate for turning-back position and the various types of information stored in the vehicle information DB 21.

Thereafter, at S18, the CPU 31 calculates the backward trajectories of the towing vehicle 2 and the towed vehicle 3 in a case where it is assumed that the backward movement is started from the candidate for turning-back position to be processed, based on the recommended values of the turning curvature X, the steering-angle increment curvature gradient α, and the steering-angle decrement curvature gradient β acquired at S16 above and the initial curvature specified at S17 above. In addition, an approach angle Δθ (also corresponding to an angle amount required for turning to enter the parking target position) from the candidate for turning-back position to be processed to the parking target position is specified based on the parking target position acquired at S11 above and the candidate for turning-back position to be processed (see FIG. 6), and the backward trajectory calculated at S18 above is a trajectory made to match the approach angle Δθ. The trajectory is made to match the approach angle Δθ, however, it does not matter whether the backward trajectory passes the parking target position. Note that, the backward trajectories of both the towing vehicle 2 and the towed vehicle 3 are not necessarily calculated, and either one of the backward trajectories may be calculated.

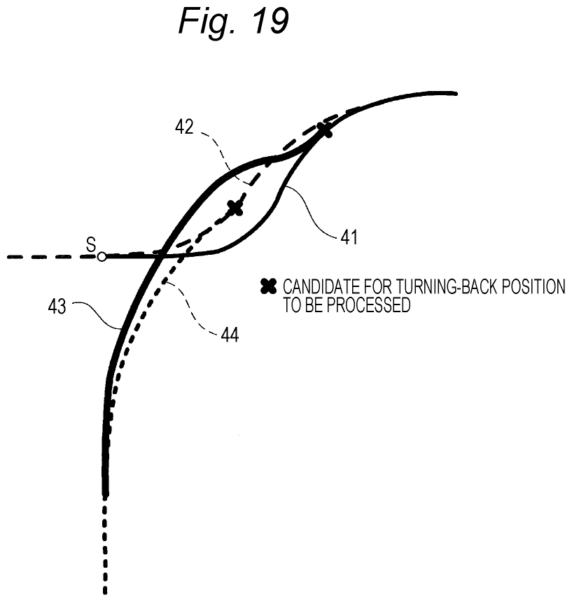

Here, FIG. 19 is a diagram illustrating an example of backward trajectories calculated at S18 above. As illustrated in FIG. 19, a backward trajectory 43 of the towing vehicle 2 is a trajectory for moving backward from a candidate for turning-back position to be processed which is set on the forward trajectory 41 of the towing vehicle 2. In addition, a backward trajectory 44 of the towed vehicle 3 is a trajectory for moving backward from a candidate for turning-back position to be processed which is set on the forward trajectory 42 of the towed vehicle 3.

In particular, the backward trajectory 43 of the towing vehicle 2 is a traveling trajectory including the counter steering motion and the steering-angle increment motion above, and the backward trajectory 44 of the towed vehicle 3 includes a section (first section) in which the towing vehicle travels while increasing the curvature with the recommended steering-angle increment curvature gradient α from the initial curvature to the recommended turning curvature X, a section in which the towing vehicle travels while maintaining the turning curvature X, and a section (second section) in which the towing vehicle travels while decreasing the curvature with the recommended steering-angle decrement curvature gradient β from the turning curvature X.

Note that the backward trajectories 43 and 44 are made to match the approach angles Ae to the parking target positions. That is, the backward trajectories 43 and 44 are trajectories on which turning is performed by an amount necessary for entering the parking target position, but do not necessarily pass the parking target position.

After the processing from S16 to S18 is executed for all the candidates for turning-back position set at S15 above and the backward trajectories are calculated, the step proceeds to S19.

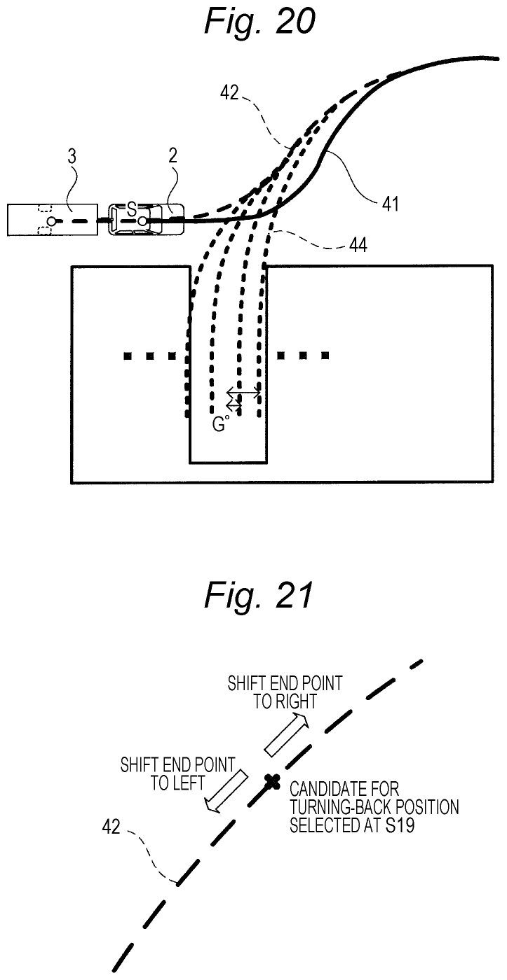

At S19, the CPU 31 compares the backward trajectories calculated at S18 for each of the candidates for turning-back position, and selects a candidate for turning-back position which makes the end point of the backward trajectory closest to the parking target position, from among the plurality of candidates for turning-back position. Note that the backward trajectories of the towing vehicle 2 may be compared, or the backward trajectories of the towed vehicle 3 may be compared. For example, FIG. 20 illustrates an example in which the backward trajectories 44 of the towed vehicle 3 are compared, and in the example illustrated in FIG. 20, the end point of the backward trajectory 44 second from the right is closest to the parking target position G, so that the candidate for turning-back position corresponding to the backward trajectory 44 discussed above is selected.

Next, at S20, the CPU 31 corrects the candidate for turning-back position selected at S19 above in a direction in which the end point of the backward trajectory approaches the parking target position, and finally determines the corrected candidate for turning-back position as the turning-back position. For example, in a case where the backward trajectories 44 of the towed vehicle 3 are compared as illustrated in FIG. 20, when the end point of the backward trajectory 44 on the candidate for turning-back position selected at S19 above is displaced to the right with respect to the parking target position G, the end point of the backward trajectory 44 can be brought close to the parking target position G by moving the candidate for turning-back position to the parking start position side along the forward trajectory 42 as illustrated in FIG. 21. Incidentally, when the end point of the backward trajectory 44 on the candidate for turning-back position selected at S19 above is displaced to the left with respect to the parking target position G, the end point of the backward trajectory 44 can be brought close to the parking target position G by moving the candidate for turning-back position to the side (forward) away from the parking start position along the forward trajectory 42 as illustrated in FIG. 21.

However, in the correction at S20, it is desirable that the candidate for turning-back position is corrected to be located at a position forward (the side away from the parking start position) by a predetermined distance (for example, 30 cm) along the forward trajectory from the turning-back position which makes the end point of the backward trajectory is made to completely match the parking target position. As a result, in a case where an error occurs in measurement or calculation during the processing from S11 to S20 described above, that is, even in a case where the trajectory for moving backward from the turning-back position, finally determined at S20 above, is actually a trajectory that makes it difficult to reach the parking target position, correction can be performed in the middle of backward movement without doing parking again.

Subsequently, at S21, the CPU 31 outputs, as a recommended traveling trajectory from the parking start position to the parking target position, a combination of the forward trajectory to the turning-back position determined at S20 above and the backward trajectory for moving backward from the turning-back position determined at S20, among the forward trajectories acquired at S13 and S14 above. Note that the calculation of the backward trajectory for moving backward from the turning-back position determined at S20 above is similar to S18 above, and thus the explanation is omitted. Note that, at S21 above, either one of traveling trajectories of the towing vehicle 2 and the towed vehicle 3 may be output. In addition, the traveling trajectory of the towing vehicle 2 may be output as the forward trajectory and the traveling trajectory of the towed vehicle 3 may be output as the backward trajectory, or vice versa.

In addition, subsequently, the parking assistance device 1 can perform parking assistance of the towing vehicle 2 by controlling each drive unit, based on the traveling trajectory output at S21 above. Specifically, the parking assistance device 1 transmits various types of assistance information regarding automatic driving assistance, such as traveling trajectory generated at S21 above, to the vehicle control ECU 24 via the CAN. The vehicle control ECU 24 performs automatic driving assistance by using the received various types of assistance information. Specifically, the steering, the drive source, the brake, and the transmission are controlled such that the towing vehicle 2 moves from the parking start position to the parking target position along the traveling trajectory generated at S21 above. Note that, in the automatic driving assistance described above, only the steering operation may be automatically performed, and the operation of the accelerator, the brake, and the shift position may be manually performed. Incidentally, it is not essential to equip the towing vehicle 2 with the automatic driving assistance described above, and the towing vehicle 2 may be a vehicle that allows only manual driving. In this case, steering operating guidance and brake, accelerator, and shift-position operating guidance for traveling along a traveling trajectory generated at S21 above are performed, instead of the automatic driving assistance described above.

In addition, during the transition to the parking assistance mode, it is desirable to display the traveling trajectory and the current position of the vehicle in a comparable state on the liquid crystal display 15 to cause the driver to confirm whether the parking operation has been performed according to the generated traveling trajectory. Furthermore, a bird's-eye view image viewed from above may be generated based on surrounding images captured by cameras installed in the towing vehicle 2 and the towed vehicle 3, and the bird's-eye view image may be displayed on the liquid crystal display 15 during the transition to the parking assistance mode.

As explained above in detail, with the parking assistance device 1 and the computer program executed by the parking assistance device 1 according to the present embodiment, the maximum value of the curvature or the steering angle allowed for the traveling trajectory of the towing vehicle 2 is set (S3), the trailer wheel base that is the distance from the turning center of the towed vehicle 3 to the coupling point and the coupling distance that is the distance from the rear axle of the towing vehicle 2 to the coupling point between the towing vehicle 2 and the towed vehicle 3 are acquired (S1), and the recommended values of the turning curvature and the curvature gradient of the second section on the traveling trajectory during parking of the towed vehicle 3 are respectively specified based on the trailer wheel base and the coupling distance on the condition that the curvature or the steering angle for the traveling trajectory of the towing vehicle 2 does not exceed the maximum value (S4 to S8), so that, in consideration of the maximum value of the curvature or the steering angle allowed in the traveling trajectory of the towing vehicle, it is possible to specify the recommended values of the maximum value and the gradient of the curvature of the traveling trajectory of the towed vehicle, based on the trailer wheel base, which is the distance from the turning center of the towed vehicle 3 to the coupling point, and the distance from the rear axle of the towing vehicle to the coupling point. As a result, it is possible to calculate a more appropriate traveling trajectory using the recommended values without generating a traveling trajectory that is untraceable during parking.

In addition, the recommended value of the curvature gradient of the first section is specified based on the trailer wheel base and the coupling distance on the condition that the curvature or the steering angle for the traveling trajectory of the towing vehicle 2 does not exceed the maximum value (S4 to S8), so that it is possible to specify the recommended value of the gradient of the curvature of the traveling trajectory of the towed vehicle that is increased particularly when the counter steering motion is performed.

In addition, the recommended values of the predetermined turning curvature, the curvature gradient of the first section, and the curvature gradient of the second section are respectively specified with priority given to shortening of the entire length of the path for parking (S4 to S8), so that a traveling trajectory that is untraceable during parking is not generated and it is possible to calculate the traveling trajectory on which parking is completed with the shortest possible movement.

In addition, a first maximum value allowed in a traveling trajectory on which the towing vehicle 2 turns in the same direction as the towed vehicle 3 and a second maximum value allowed in a traveling trajectory on which the towing vehicle 2 turns in a direction different from the towed vehicle 3 are respectively set, and furthermore, the second maximum value has a value smaller than the first maximum value, so that it is possible to properly set the maximum allowable values of the curvature and the steering angle in consideration of the turning direction.

Note that the present disclosure is not limited to the embodiment described above, and of course, various improvements and modifications can be made without departing from the gist of the present disclosure.

For example, in the present embodiment, when the maximum curvature allowed for the traveling trajectory of the towing vehicle 2 is set (S3) in the parameter specifying processing program (see FIG. 5), the first maximum curvature allowed in a traveling trajectory on which the towing vehicle 2 turns in the same direction as the towed vehicle 3 (the right direction along the backward direction in the example illustrated in FIG. 6) and the second maximum curvature allowed in a traveling trajectory on which the towing vehicle 2 turns in a direction different from the towed vehicle 3 (the left direction along the backward direction in the example illustrated in FIG. 6) are respectively set, and furthermore, the second maximum curvature has a value smaller than the first maximum curvature, but the first maximum curvature may have a value equal to the second maximum curvature or a value smaller than the second maximum curvature.

In addition, in the present embodiment, the maximum curvature allowed for the traveling trajectory of the towing vehicle 2 is set, but it is also possible to set a maximum allowed steering angle instead of the curvature.

Note that a curvature drawn by the traveling trajectory of the towing vehicle 2 and the steering angle of the towing vehicle 2 traveling along the traveling trajectory are basically interlocked, the present embodiment can be embodied without any problem even when the maximum steering angle instead of the maximum curvature is set.

In addition, in the present embodiment, the recommended values of the turning curvature X, the steering-angle increment curvature gradient α, and the steering-angle decrement curvature gradient β are specified in the parameter specifying processing program (see FIG. 5). However, instead of specifying the recommended values of all the parameters, the recommended values of only some parameters may be specified.

In addition, in the present embodiment, the parking assistance processing program (FIG. 14) selects a candidate for turning-back position which makes the end point of the backward trajectory closest to the parking target position, from among the plurality of candidates for turning-back position (S19), and furthermore, corrects the selected candidate for turning-back position (S20) to determine the corrected candidate for turning-back position as the turning-back position. However, the correction at S20 is not necessarily performed. That is, the candidate for turning-back position selected at S19 above may be determined as the turning-back position.

In addition, in the present embodiment, the parking assistance ECU 23 of the parking assistance device 1 is configured to execute the processing of the parameter specification processing program (see FIG. 5) and the parking assistance processing program (FIG. 14), but the execution subject can be appropriately changed. For example, the control unit of the liquid crystal display 15, the vehicle control ECU, the control unit of the navigation device, and other on-vehicle devices may be configured to execute the processing.

A parking assistance device that assists parking of a towing vehicle and a towed vehicle to be towed by the towing vehicle in a state where the towing vehicle and the towed vehicle are coupled, a traveling trajectory of the towed vehicle during parking including a first section directing backward and increasing a curvature from an initial curvature at a start of backward movement to a predetermined turning curvature and a second section directing backward and decreasing the curvature from the predetermined turning curvature, the parking assistance device including: a maximum value setting unit that sets a maximum value of a curvature or a steering angle allowed for the traveling trajectory of the towing vehicle; a trailer wheel base acquisition unit that acquires a distance from a turning center of the towed vehicle to a coupling point between the towing vehicle and the towed vehicle as a trailer wheel base; a coupling distance acquisition unit that acquires a coupling distance that is a distance from a rear axle of the towing vehicle to the coupling point between the towing vehicle and the towed vehicle; and a parameter specification unit that specifies respective recommended values of the predetermined turning curvature in the traveling trajectory of the towed vehicle during parking and a curvature gradient of the second section based on the trailer wheel base and the coupling distance on a condition that a curvature or a steering angle for the traveling trajectory of the towing vehicle does not exceed the maximum value.

With the parking assistance device according to the present disclosure having the configuration described above is able to specify the recommended values of the maximum value and the gradient of the curvature of the traveling trajectory of the towed vehicle, based on the trailer wheel base and the distance from the rear axle of the towing vehicle to the coupling point in consideration of the maximum value of the curvature or the steering angle allowed in the traveling trajectory of the towing vehicle. As a result, it is possible to calculate a more appropriate traveling trajectory using the recommended values without generating a traveling trajectory that is untraceable during parking.

In the parking assistance device according to the present disclosure having the configuration described above, the parameter specification unit specifies a recommended value of a curvature gradient of the first section, based on the trailer wheel base and the coupling distance on a condition that a curvature or a steering angle for the traveling trajectory of the towing vehicle does not exceed the maximum value.

With the parking assistance device according to the present disclosure having the configuration described above, it is possible to specify a recommended value of the gradient of the curvature of the traveling trajectory of the towed vehicle that is increased particularly when the counter steering motion is performed.

In the parking assistance device according to the present disclosure having the configuration described above, the parameter specification unit specifies respective recommended values of the predetermined turning curvature, the curvature gradient of the first section, and the curvature gradient of the second section by giving priority to shortening of the entire length of the path for parking.

With the parking assistance device according to the present disclosure having the configuration described above, a traveling trajectory that is untraceable during parking is not generated and it is possible to calculate the traveling trajectory on which parking is completed with the shortest possible movement.

In the parking assistance device according to the present disclosure having the configuration described above, the maximum value setting unit sets respective first maximum value and second maximum value, the first maximum value being allowed in a traveling trajectory on which the towing vehicle 2 turns in the same direction as the towed vehicle 3, the second maximum curvature being allowed in a traveling trajectory on which the towing vehicle 2 turns in a direction different from the towed vehicle 3, and furthermore, the second maximum value has a value smaller than the first maximum value, so that it is possible to properly set the maximum allowable values of the curvature and the steering angle in consideration of the turning direction.

With the parking assistance device according to the present disclosure having the configuration described above, it is possible to properly set the maximum allowable values of the curvature and the steering angle in consideration of the turning direction.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A parking assistance device that assists parking of a towing vehicle and a towed vehicle to be towed by the towing vehicle in a state where the towing vehicle and the towed vehicle are coupled,
a traveling trajectory of the towed vehicle during parking including a first section directing backward and increasing a curvature from an initial curvature at a start of backward movement to a predetermined turning curvature and a second section directing backward and decreasing the curvature from the predetermined turning curvature, the parking assistance device comprising:
a maximum value setting unit that sets a maximum value of a curvature or a steering angle allowed for the traveling trajectory of the towing vehicle;
a trailer wheel base acquisition unit that acquires a distance from a turning center of the towed vehicle to a coupling point between the towing vehicle and the towed vehicle as a trailer wheel base;
a coupling distance acquisition unit that acquires a coupling distance that is a distance from a rear axle of the towing vehicle to the coupling point; and
a parameter specification unit that specifies respective recommended values of the predetermined turning curvature in the traveling trajectory of the towed vehicle during parking and a curvature gradient of the second section based on the trailer wheel base and the coupling distance on a condition that a curvature or a steering angle for the traveling trajectory of the towing vehicle does not exceed the maximum value.

2. The parking assistance device according to claim 1, wherein the parameter specification unit specifies a recommended value of a curvature gradient of the first section, based on the trailer wheel base and the coupling distance on a condition that a curvature or a steering angle for the traveling trajectory of the towing vehicle does not exceed the maximum value.

3. The parking assistance device according to claim 2, wherein the parameter specification unit specifies respective recommended values of the predetermined turning curvature, the curvature gradient of the first section, and the curvature gradient of the second section by giving priority to shortening of the entire length of the path for parking.

4. The parking assistance device according to claim 1, wherein
the maximum value setting unit sets respective first maximum value and second maximum value, the first maximum value being allowed in a traveling trajectory on which the towing vehicle turns in the same direction as the towed vehicle, the second maximum value being allowed in a traveling trajectory on which the towing vehicle turns in a direction different from the towed vehicle, and
the second maximum value has a value smaller than the first maximum curvature.

5. The parking assistance device according to claim 2, wherein
the maximum value setting unit sets respective first maximum value and second maximum curvature, the first maximum value being allowed in a traveling trajectory on which the towing vehicle turns in the same direction as the towed vehicle, the second maximum value being allowed in a traveling trajectory on which the towing vehicle turns in a direction different from the towed vehicle, and
the second maximum value has a value smaller than the first maximum value.

6. The parking assistance device according to claim 3, wherein
the maximum value setting unit sets respective first maximum curvature and second maximum curvature, the first maximum curvature being allowed in a traveling trajectory on which the towing vehicle turns in the same direction as the towed vehicle, the second maximum curvature being allowed in a traveling trajectory on which the towing vehicle turns in a direction different from the towed vehicle, and
the second maximum curvature has a value smaller than the first maximum curvature.
